(19) United States
(12) Patent Application Publication
(10) Pub. No.: US 2010/0136808 A1
(43) Pub. Date: Jun. 3, 2010

(54) Electrical Connector

(75) Inventor: Augusto Vanzo, Baranzate (IT)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignees: Van-System s.r.l., Baranzate (IT); Ten 47 Limited, Dysart Kirkcaldy Fife (GB)

(21) Appl. No.: 12/593,112

(22) PCT Filed: Mar. 27, 2007
(86) PCT No.: PCT/IB07/03221

§ 371 Date: Feb. 12, 2010

(51) Int. Cl. H01R 25/00; H01R 43/16

(52) U.S. Cl. 439/118; 29/874

(57) ABSTRACT

A single pole power connector system includes a plurality of single pole connectors for carrying electric current in a multi-phase power applications. A single pole connector can be provided for each phase or line of the application. The single pole connectors can include mating male plugs and female receptacles. To releasably couple the male plugs and female receptacles of each single pole connector together, the plugs and receptacles can include between them a coupling feature. To prevent or avoid misconnections between male plugs and female receptacles of different single pole connectors, the plugs and receptacles can also include between themselves a polarization feature. The polarization feature can be angularly offset with respect to the coupling feature so that the plugs and receptacles can only couple with their intended pair.

### BACKGROUND OF THE INVENTION

Single pole electrical connectors are often employed to facilitate high current, high voltage power distribution in various temporary or modular power systems such as, for example, movie or film making sets, fair or carnival settings, shipping equipment and transportation facilitates. The power required in such settings and applications is often three-phase electrical power and may require current loads in the range of 400 amps, or may operate in excess of or below 400 amps. To transmit such power, multiple, large-diameter, flexible cables can be used. To accommodate the three-phase power requirement, a cable is usually provided for each phase or line and another cable is provided for ground. In some applications, an additional cable may be provided for neutral, as will be appreciated by those of skill in the art. Accordingly, up to five separate cables or lines may be necessary for transmitting three-phase power. To facilitate the temporary connecting of such power systems, the single pole connectors are configured to provide releasable connections between the cables and/or the power consuming equipment.

### BRIEF SUMMARY OF THE INVENTION

In accordance with the various aspects of the invention, there is disclosed various systems and methods utilizing a plurality of single pole power connectors that can be used for distribution of high current, three-phase power. Each single pole connector of the plurality can include a male plug connector half or part and a corresponding female receptacle connector half or part that can be mated or coupled together to form a releasable electrical connection. The male plug connector and female receptacle connector may have a general cylindrical shape or form that can delineate an axis line about which the male plug and female receptacle connectors can be aligned when mating. Coupling of the male plug and female receptacle can be accomplished by a coupling feature formed and operable between both of the parts.

To prevent or inhibit misconnections amongst the various phases, grounds, and neutral lines or sources, each of the single pole power connectors can include a polarization feature. In an aspect, the polarization feature can include interconnecting or engaging structures formed on both of the mating male plug and female receptacle connector parts. To effect polarization, the polarization structures of each of the single pole connectors is angularly offset in reference to the axis line and with respect to the coupling feature of that same single pole connector. Moreover, the amount of angular offset between the coupling feature and polarization feature for each single pole connector in the system is different.

An advantage of the disclosed single pole connector systems and methods is that it facilitates temporary distribution systems for the handling of large current, high powered and multi-phase applications. Another advantage is that it prevents or inhibits misconnection between the various phases, grounds, and neutral lines or sources involved in such systems. These and other advantages and features of the inventive aspects will become apparent from the foregoing drawings and detailed description of the embodiments.

### BRIEF DESCRIPTION OF THE DRAWINGS

FIG. 1 is a perspective view of a single pole connector for use with a plurality of similar connectors to provide a single pole connector system, the single pole connector including a male plug portion and a respective female receptacle portion.

FIG. 2 is a cross-sectional view taken along line A-A of FIG. 1 showing in cross-section the male plug and female receptacle connectors aligned for mating or coupling together, and further showing an additional embodiment of the male plug connector for diagrammatical explanation.

FIG. 3 is a cross-sectional view similar to that of FIG. 2 showing the male plug and female receptacle connectors mated or coupled together.

FIG. 4 is a diagrammatical view of the coupling and polarization features of the single pole connector system.

FIG. 5 is a perspective view of another embodiment of a single pole connector for use in a multi-connector system.

### DETAILED DESCRIPTION OF THE EMBODIMENTS

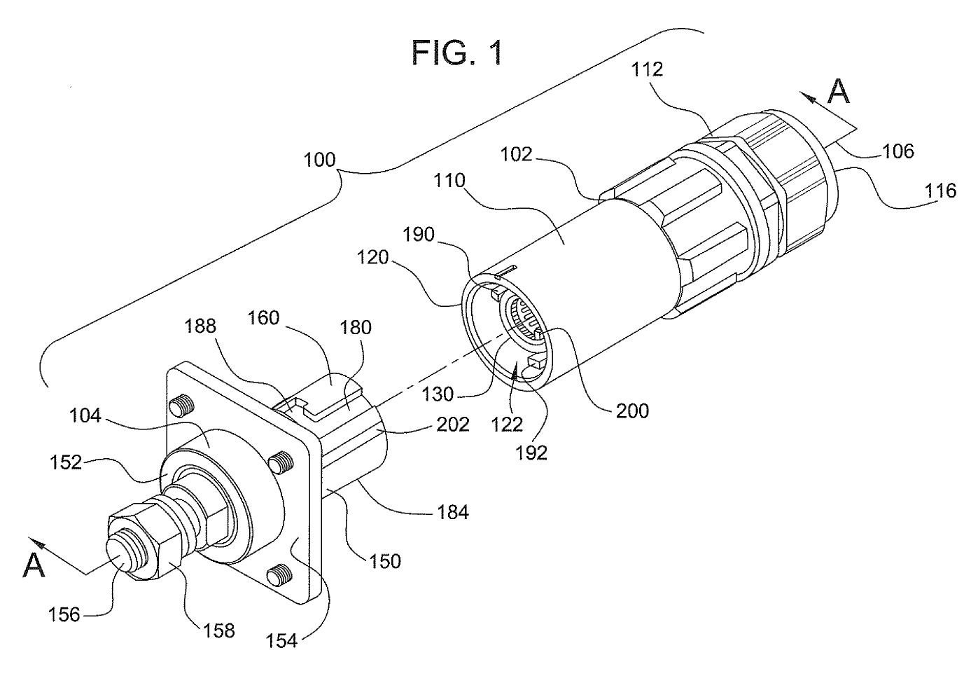

Now referring to the drawings, wherein like reference numbers refer to like elements, there is illustrated in FIG. 1 a single pole connector 100 for use in a high current, three-phase electrical power distribution system. It will be appreciated that in such a three-phase system the illustrated single pole connector 100 can be one of a plurality of like connectors that are provided for establishing releasable connections between cables or lines from the power source and the power consuming equipment. In other words, a single pole connector 100 or its like can be provided for each of the three electrical phases or lines, for the ground line, and for a neutral line if included.

The single pole connector 100 includes two releasably mating parts or halves, referred to herein as a female receptacle 102 and a corresponding male plug 104. In the embodiment illustrated, the female receptacle 102 is configured for attachment to a flexible, high current power cable while the male receptacle 104 is configured for panel attachment to a wall or similar structure of the power consuming equipment. However, either of these attachment features or various different ones can be exchanged between the female receptacle and male plug without deviating from the nature of the invention.

The female receptacle 102 has an elongated, generally cylindrical shape that delineates, for reference purposes, an axis line 106. The cylindrical shape is determined by the exterior surface of a tubular receptacle body 110. The receptacle body 110 can be made from an insulative material, such as molded thermoplastic, for the purpose of insulating and protecting the conductive components located inside the body. To attach to a cable, the receptacle body 110 includes at its first connecting end 112 a strain relief 116 which includes and can manipulate an adjustable grommet. The strain relief 116 can receive the cable and be twisted or rotated about the axis line 106 to tighten or fasten the grommet about the cable in the well known manner.

Opposite of the connecting end 112 of the receptacle body 110 is a mating end 120 having a smooth, cylindrical exterior surface. The mating end 120 includes an axially disposed opening 122 for permitting access to the interior of the receptacle body 110 and the conductive components located therein. Accordingly, the mating end 120 is generally hollow to accommodate the conductive components.

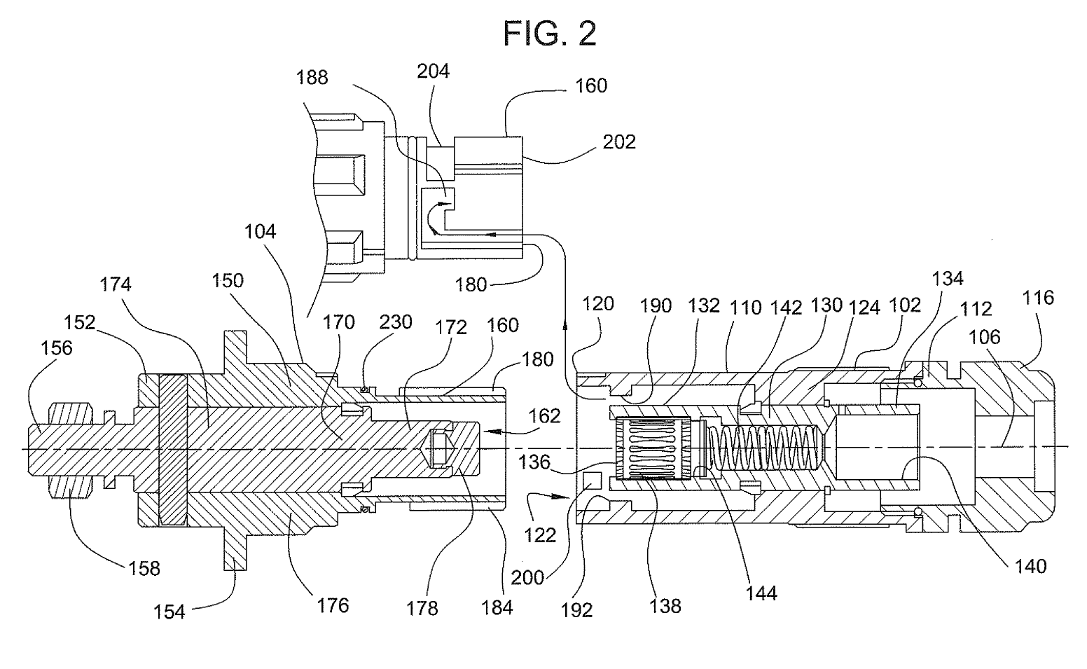

Referring to FIGS. 1 and 2, the conductive components of the female receptacle connector 102 include a socket contact 130 that can be made from any suitable electrically conductive materials such as, for example, copper or brass. The socket contact 130 can have a cylindrical, generally tubular shape and extends between a contact end 132 and an opposite attachment end 134. The contact end 132 is at least partially located within the opening 122 of the receptacle body 120 while the opposing attachment end 134 is oriented toward the connecting end 112. To hold the socket contact 130 coaxially within the receptacle body 110, the receptacle body may include a circular shoulder 124 projecting radially inward and extending annularly about the socket contact approximately midway between the contact end 132 and the attachment end 134.

Disposed into the contact end 132 towards the attachment end 134 is a cylindrical recess 136 that is sized to receive a respective conductive component from the male plug 104. To ensure good electrical contact and as will be explained in further detail below, the contact end 132 further includes a plurality of electrically conductive, resilient fingers 138 or strings that are radially aligned about the inner wall delineating the recess 136 and that can project or are biased radially inward. The resilient fingers 138 can be produced by forming slots or scores into the inner wall of the contact end 132 or by attaching separate wires or strips of conductive material about the inner wall.

To electrically connect the socket 130 with a cable entering the strain relief 116, there is disposed into the attachment end 134 a bore 140. The bore 140 is adapted to receive and be crimped or otherwise secured about the stripped conductive wires or strands of the cable. The socket 130 can also include a helical spring 142, whose purpose will be described below, that is retentively held within the socket coaxial to the axis line 106. The spring 142 can be made from electrically conductive material and is positioned to project partially into the recess 136 to abut against an annular ledge or stop 144 formed as part of the contact end 132 that is directed radially inward.

Referring back to FIG. 1, the male plug 104 includes a plug body 150 that, for reference purposes, is also oriented about the axis line 106 and can also be made from a suitable insulative material such as thermoplastic. The plug body 150 extends along the axis line 106 between a mating end 160 and a connecting end 152. To configure the male plug 104 for panel mounting, the plug body 150 further includes a generally square mounting flange 154 located approximately midway between the mating end 160 and the connecting end 152 and perpendicular to the axis line 106. As will be appreciated, the flange 154 can be mounted to the wall of the power consuming equipment about a hole therein such that the connecting end 152 projects into the interior of the equipment while the mating end 160 is exposed to the exterior. Further, the connecting end 152 includes a threaded stud 156 and corresponding nut 158 that can be tightened down to clamp the exposed wires or terminals of the equipment thereby establishing electrical communication therewith.

The mating end 160 of the plug body 150 projects axially forward of the flange 154 and has a generally cylindrical tubular shape. The cylindrical mating end 160 is sized to be slidingly received through the opening 122 of the corresponding mating end 120 of the female receptacle 102.

Referring to FIG. 2, the plug body 150 houses a contact pin 170 that is accessible via a circular opening 162 disposed through the front of the mating end 160. Accordingly, the mating end 160 is substantially hollow. The contact pin 170 can be made from an electrically conductive material, such as copper or brass, and includes a contact end 172 and an opposing attachment end 174. Both the contact end 172 and the attachment end 174 can be cylindrical in shape with the contact end being smaller in diameter than the attachment end.

To retain the contact pin 170 and hold it aligned about the axis line 106, the plug body 150 can include a circular shoulder 176 that projects radially inward and extends annularly about the contact pin approximately midway between the contact end 172 and the attachment end 174. Accordingly, the contact end 172 of the connecting pin projects into the hollow mating end 160 and is directed toward the opening 162. For safety purposes, attached to the tip of the contact end 172 can be a protective nose 178 made of electrically non-conductive material. The protective nose 178 is intended to prevent electrocution of anything accidentally inserted in to the opening 162. If desired, similar protective features can be included as part of the female receptacle. To establish electrical contact between the contact pin 170 and the power consuming equipment, the attachment end 174 extends from the rear of the plug body 150 and terminates in the threaded stud 156 and corresponding nut 158.

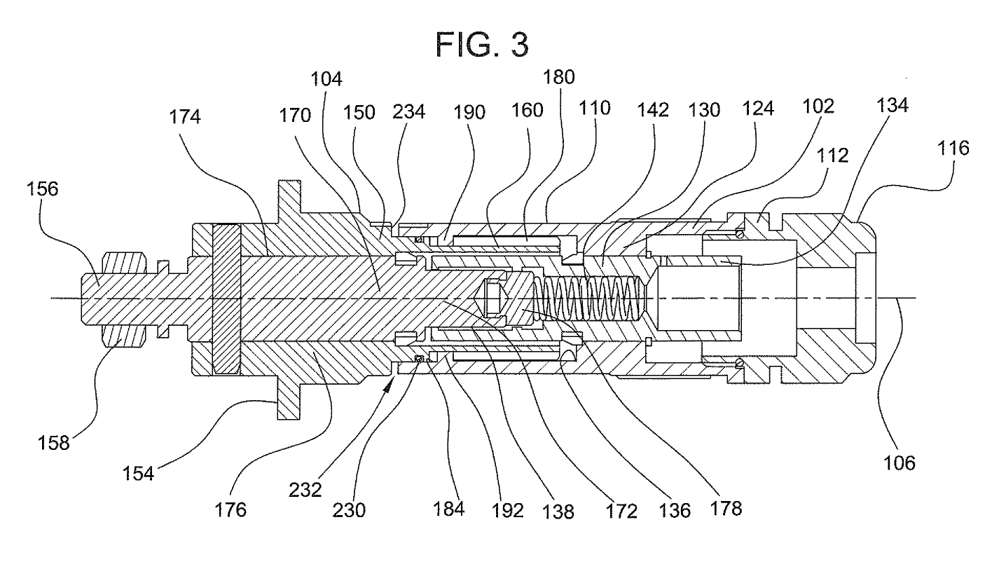

Referring to FIGS. 2 and 3, to couple the female receptacle 102 and male plug portions 104 of the electrical connector, the two portions can be aligned about the axis line 106 and axially moved together. As can be appreciated, the mating end 160 of the male plug 104 can be slidably inserted into the opening 122 of the mating end 120 of the female receptacle 102 where it can be received between the surrounding receptacle body 110 and the contact end 132 of the socket 130 inside. After the mating end 160 of the male plug 104 has been inserted a predetermined distance into the mating end 120 of the female receptacle 102, the conductive contact pin 170 will begin to slide into the recess 136 of the socket connecting end 132. While the contact pin connecting end 172 is sized to be received in the recess 136 of the socket connecting end 132, the spring fingers 138 projecting radially inward can contact, be displaced by, and urge back against the contact pin 170. Sufficient, 360° degree electrical contact is thereby maintained between and across the female receptacle connector 102 and the male plug connector 104.

To hold the mated female receptacle 102 and male plug 104 together, the single pole connector 100 can include a coupling feature. In the example illustrated in FIGS. 1 and 2, the coupling feature can include a J-shaped channel 180 disposed radially into the exterior surface of the mating end 160 of the plug body 150. The J-shaped channel 180 starts from the tip of the mating end 160 and extends in a first direction toward the connecting end 152 and parallel to the axis line 106. Proximate the rear of the mating end 160, the channel 180 extends a second direction normal to the first direction and radial with respect to the axis line 106. The channel 180 can extend in a radial second direction that is normal to the first direction for about 20° to 30° of the circumference. The J-shaped channel 180 next extends back toward the tip of the plug body 150 in a direction parallel to the axis line 106 to form a catch 188. A second J-shaped channel 184 can be disposed into the surface of the plug body 180° about the circumference from the first J-shaped channel.

To engage the J-shaped channels 180, 184, the coupling feature can further include first and second mating tabs 190, 192 formed on the mating end 120 of the receptacle body 119. The mating tabs 190, 192 can project radially inward and can be located proximate to the opening 122. When the mating end 160 of the male plug 104 is inserted into the opening 122 of the mating end 120 of the female receptacle 102, the mating tabs 190, 192 can enter the channels 180, 184 as indicated by the arrow in FIG. 2. The mating tabs 190, 192 pass through the J-shaped channels 180, 184 to the point where the catch 188 is located. The female receptacle can then be rotated with respect to the male plug so that the mating tabs 190, 192 slide into the catch portions 188 of the channels.

Additionally, the contact pin connecting end 172 can be received into the recess 136 of the socket 130 so as to abut and displace the spring 142 which can urge back against the contact pin 170. As can be appreciated, the spring 142 therefore forces the female receptacle and male plug 102, 104 to push apart thereby causing the mating tabs 190, 192 to securely seat within the catch 188. To un-mate the connector, the female receptacle 102 and male plug 104 must first be axial moved or forced together so as to overcome the spring biasing force and to cause the mating tabs 190, 192 to unseat from the catch 188. The female receptacle connector and male plug connector can then be rotated and pulled apart so that the mating tabs can move back through the J-shaped slots. Hence, cooperation between the catch 188 and spring 142 can provide a safety feature that prevents accidental or unintended decoupling of the connector 100.

To help prevent the incorrect coupling of the plurality of male plugs and female receptacles that are provided for the different phases or lines of electrical power, each single pole connector in the system can include a polarization feature. Referring to FIGS. 1 and 2, the polarization feature includes a protruding key 200 that can be formed on the inner surface of the receptacle body 110 and which is directed radially inward. The polarization feature can also include a corresponding slot 202 disposed into the exterior surface of the plug body mating end 160. Similar to the channels 180, 184, the slot 202 extends in a first direction from the tip of the mating end 160 toward the attachment end 152 and parallel to the axis line 106. The slot 202 can then extend radially in a second direction normal to the first direction to provide a leg 204 partially about circumference. The slot 202 can be adapted to receive the protruding polarization key 200. As can be appreciated from FIGS. 1 and 2, when the female receptacle 102 and male plug 104 are mated, the polarization key 200 can be received in the slot 202 and then moved into the leg 204 by rotation of the connector portions.

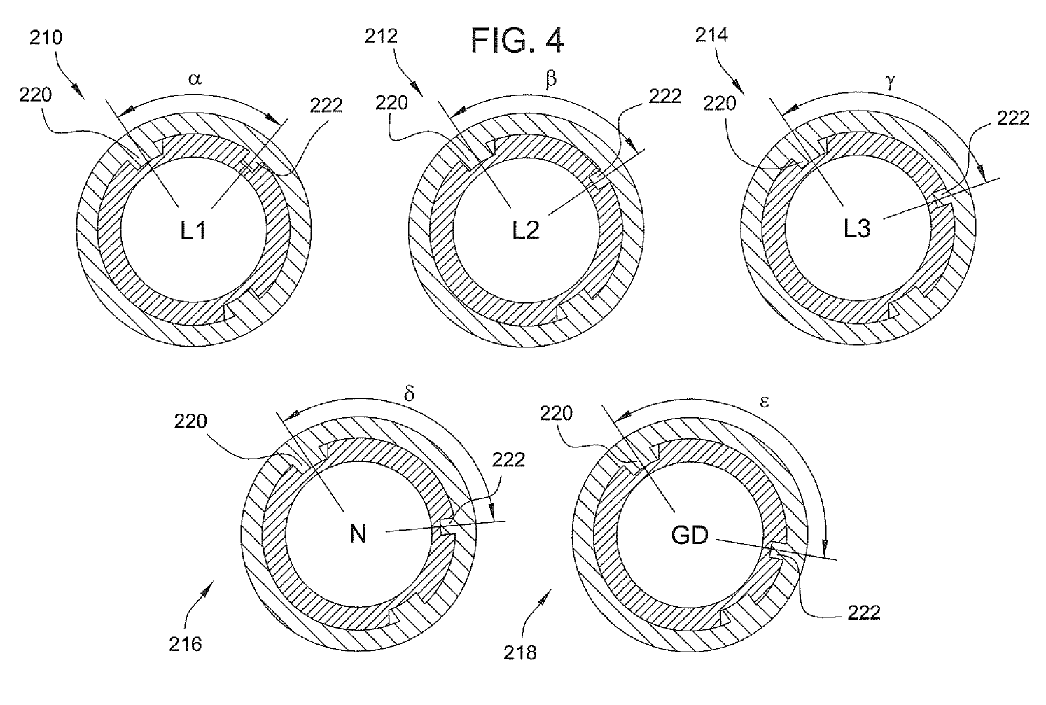

To establish polarization, the coupling feature and the polarization feature can be angularly offset with respect to each other. For example, referring to FIG. 4, there is shown diagrammatically five single pole connectors that are coupled together and are designated herein as 210, 212, 214, 216 and 218. Each of the connectors can be intended for communicating a particular phase, neutral or ground line.

The angular offset between at least one channel of the coupling feature 220 and the polarization feature 222 is different for the each of the five connectors 210, 212, 214, 216, and 218. For example, the angular offset between the channel of the coupling feature 220 and the angular feature 222 for the first connector 210 can be, as designated by angle α, 73.5°; the angular offset for the second connector 212 can be, as designated by angle β, 88.5°; the angular offset for the third connector 214 can be, as designated by angle γ, 103.5°; the angular offset for the fourth connector 216 can be, as designated by angle δ, 118.5°; the angular offset for the fifth connector 218 can be, as designated by angle ε, 133.5°. Of course, these angles are exemplary only and any other set of angular offsets can be selected. Because of the angular offsets, each of the receptacles will only mate with one plug having a corresponding angular offset. Hence, even though the single pole connector system may be provided as a set including five female receptacles and five male plugs, misconnecting of the single pole connectors can be prevented or inhibited.

The single pole connector 100 described herein can include additional beneficial features. For example, as illustrated in FIGS. 2 and 3, to form a water tight seal for protecting the internal electrical components, the male plug 104 portion of the connector can include o-ring 230 received into a groove disposed about the circumference at the mating end 160. When the connector is mated, the o-ring 230 can act as a compressible seal between the male plug mating end 160 and the female receptacle mating end 120. Another advantage appreciable from FIG. 3 is that because the spring 142 axially displaces the female receptacle 102 and male plug 104, a gap 232 can be caused to form between the tip of the female receptacle mating end 120 and a corresponding shoulder 234 on the plug body 150. If desired, a plastic tie-down wrap, wire or similar item can be placed into the gap 232 and wrapped around the male plug 104 to prevent the female receptacle 102 and male plug from being moved together as required to decouple the connector. Hence, blocking the gap provides an additional safety function by further helping to prevent unintended decoupling of the connector.

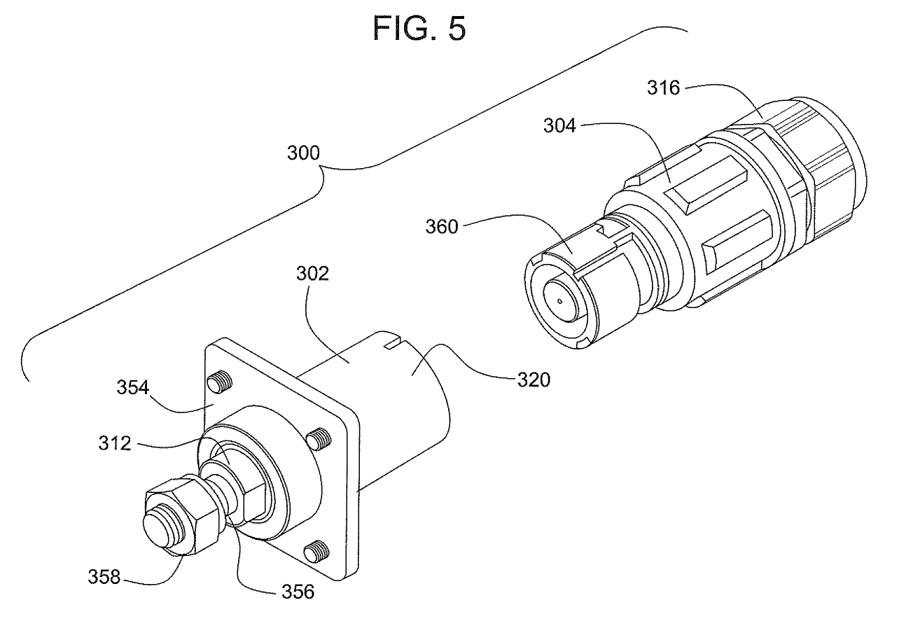

As explained above, the female receptacle and male plug are interchangeable with respect to whether they are configured for panel attachment or cable attachment. For example, referring to FIG. 5, there is illustrated a single pole connector 300 in which the female receptacle connector 302 is configured for panel attachment. The female connector 302 has a flange 354 attached thereto and located in between the forward mating end 320 and the rearward connecting end 312. Furthermore, the female receptacle connecting end 312 can include a threaded stud 356 and nut 358 to secure the internal wires of the power consuming equipment. The male plug connector 304 includes strain relief 316 for accepting a power cable that is attached rearward of the male plug mating end 360. Hence, the attachment features of the female receptacle and the male plug are reversed from that shown in FIG. 1. In other embodiments, the female receptacle and male plug can both be configured for attachment to a cable, to a panel, or any other suitable attachment.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A single pole connector system comprising:
a plurality of single pole connectors, each connector having a male plug and a corresponding female receptacle, the male plug including a plug body extending along a first axis line and a contact pin generally within the plug body, the female receptacle having receptacle body extending along a corresponding axis line and a socket within the receptacle body, the socket adapted to accommodate the contact pin when the male plug and female receptacle are coupled;
the single pole connectors each further including a coupling feature including a channel disposed into a surface of either the plug body or the receptacle body, the channel adapted to receive a mating tab protruding from the surface of the other of the plug or receptacle bodies;
the single pole connectors further including a polarization feature including a slot disposed into a surface of either the plug body or the receptacle body, the slot adapted to receive a key protruding radially from the surface of the other of the plug or receptacle bodies, wherein the slot and key are angularly offset with respect to the channel and tab, and the angular offset being different for each of the plurality of single power connectors.

2. The single pole connector system of claim 1, wherein the plurality of single pole connectors is five single pole connectors.

3. The single pole connector system of claim 2, wherein the angular offset of the first connector is approximately 73.5°, the angular offset of the second connector is approximately 88.5°, the angular offset of the third connector is approximately 103.5°, the angular offset of the fourth connector is approximately 118.5°, and the angular offset of the fifth connector is approximately 133.5°.

4. The single pole connector system of claim 1, wherein the channel is disposed into the surface of the respective connector body a first direction parallel to the axis line and a second direction generally normal to the first direction.

5. The single pole connector system of claim 4, wherein the channel includes a catch proximate an intersection of the first and second directions, the mating tab adapted to be retained by the catch when the male plug and female receptacle are mated.

6. The single pole connector system of claim 5, wherein the socket contact includes a spring axially aligned along the second axis line, the spring axially urging against the contact pin when the male plug and female receptacle are mated such that the mating tab can retentively urge against the catch.

7. The single pole connector system of claim 4, wherein the coupling feature further comprises a second channel disposed into the surface of either the plug body or the receptacle body, the second channel adapted to receive a second mating tab protruding from the surface of the other of the plug or receptacle bodies, the second channel and second mating tab being opposite the respective first channel and first mating tab.

8. The single pole connector system of claim 1, wherein the plug body includes a connecting end and an axially opposite mating end, the mating end of the plug body being generally cylindrical and hollow, the contact pin being at least partially located within the mating end and accessible via an opening at the mating end.

9. The single pole connector system of claim 8, wherein the receptacle body includes a connecting end and an opposite mating end, the mating end of the receptacle body being generally cylindrical and hollow, the mating end including an axial opening at the mating end for receiving the plug body when the female receptacle and male plug are mated.

10. The single pole connector system of claim 9, wherein the socket includes a recess disposed into an end thereof and sized to accommodate the contact pin.

11. The single pole connector system of claim 10, wherein the contact pin is coaxially aligned with the mating end of the plug body and the socket is coaxially aligned with the mating end of the receptacle body.

12. The single pole connector system of claim 11, wherein the male plug is configured for wall mounting, the wall-mountable male plug including a threaded stud located at its connecting end and a mounting flange located between its connecting end and its mating end.

13. The single pole connector system of claim 12, wherein the female receptacle includes a strain relief at its connecting end for receiving a conductive cable.

14. The single pole connector system of claim 1, wherein the contact pin and the socket are made from electrically conductive material.

15. The single pole connector system of claim 1, wherein the plug body and the receptacle body are made of thermoplastic.

16. A method of making a single pole connector system comprising:
i) providing a first single pole connector including a male plug and a female receptacle adapted to receive the first male plug, the first single pole connector further including a first coupling feature and a first polarization feature, the first coupling feature and first polarization feature being angular offset from each other a first angular offset amount;
ii) providing a second single pole connector including a second plug and a second female receptacle adapted to receive the second male plug, the second single pole connector including a second coupling feature and a second polarization feature, the second coupling feature and second polarization feature being angularly offset from each other a second angular offset amount;
iii) aligning each of the first and second male plugs with the respective one of the first and second female receptacles, so that respective first and second polarization features and respective first and second coupling features can engage;
iv) inserting and rotating the first male plug into and with respect to the first female receptacle so that the first coupling feature engages and the first polarization feature engages; and
v) inserting and rotating the second male plug into and with respect to the second female receptacle so that the second coupling feature engages and the second polarization feature engages.

17. The method of claim 16, wherein each coupling feature includes a channel disposed into a surface of either the respective male plug or female receptacle, the channel adapted to receive a mating tab protruding from a surface of the other of the respective male plug and female receptacle.

18. The method of claim 16, wherein each polarization feature includes a slot disposed into a surface of either of the respective male plug or female receptacle, the slot adapted to receive the key protruding from a surface of the other of the respective male plug and female receptacle.

19. The method of claim 16, further comprising:
v) attaching a first power cable to at least one of the first male plug or first female receptacle;
vi) attaching a second power cable to at least one of the second male plug or second female receptacle.

20. A single pole power connector system comprising:
a first single pole connector generally delineating a first axis line and including a first male plug and a first female receptacle adapted to receive the first male plug; the first single pole connector further including a first coupling feature for engaging the first male plug and the first female plug; the first single pole connector further including a polarization feature angularly offset with respect to the first coupling feature a first angular distance; and
a second single pole connector generally delineating a second axis line and including a second male plug and a second female receptacle adapted to receive the second male plug, the second single pole connector further including a second coupling feature for engaging the second male plug and the second female receptacle; the second single pole connector further including a second polarization feature angularly offset with respect to the second coupling feature a second angular distance being different than the first angular distance.

21. The single pole power connector system of claim 20, wherein each coupling feature includes a channel disposed into a surface of either the respective male plug or female receptacle, the channel adapted to receive a mating tab protruding from a surface of the other of the respective male plug and female receptacle.

22. The single pole power connector system of claim 21, wherein each polarization feature includes a slot disposed into a surface of either of the respective male plug or female receptacle, the slot adapted to receive the key protruding from a surface of the other of the respective male plug and female receptacle.

23. The single pole power connector system of claim 22, further comprising a third single pole connector generally delineating a corresponding axis line and including a third male plug and a third female receptacle adapted to receive the third male plug, the third single pole connector further including a third coupling feature for engaging the third male plug and the third female receptacle, the third single pole connector further including a third polarization feature angular offset with respect to the third coupling feature a third angular distance being different than the first angular distance and the second angular distance.
